(19) United States
(12) Patent Application Publication
(10) Pub. No.: US 2011/0104385 A1
(43) Pub. Date: May 5, 2011

(54) APPARATUS FOR ELECTROSTATICALLY COATING A WORKPIECE AND METHOD OF REDUCING CONTAMINATION THEREOF

(75) Inventor: Alessandro Mattozzi, Stockholm (SE)

(73) Assignee: ABB Research Ltd., Zurich (CH)

(21) Appl. No.: 13/002,340

(22) PCT Filed: Jul. 4, 2008
(86) PCT No.: PCT/EP2008/058688

§ 371 Date: Jan. 3, 2011

(51) Int. Cl. B05D 1/04; B05B 5/025

(52) U.S. Cl. 427/458; 118/621

(57) ABSTRACT

To minimize contamination and improve cleanability of an apparatus for electrostatically coating workpieces, the external surfaces of the apparatus are coated with a hydrophobic and hard coating.

The present invention relates to an apparatus for electrostatically coating a workpiece and to a method of reducing contamination of such an apparatus.

### BACKGROUND

Electrostatic coating is frequently used for example in the automotive industry for painting of vehicle bodies. An apparatus for electrostatic coating comprises an atomizer for atomizing paint or coating particles. Paint particles atomized/sprayed from the atomizer are subjected to an electrostatic field generated by a high voltage, generally of −30 to −90 kV. The particles are thus charged and transferred by means of the electrostatic field to a workpiece, which in turn is grounded.

The apparatus further comprises a housing surrounding and housing the atomizer. The housing is generally made of an electrically insulating polymer material. The apparatus also comprises means for mounting the apparatus to a manipulator, for example a robot, a robot arm or a reciprocator, said mounting means often having an outer surface of electrically insulating polymer material.

Electrostatic coating is generally divided into two categories, direct electrostatic coating and indirect electrostatic coating. In the direct electrostatic coating process, the paint or coating particles are charged by means of high voltage before the particles are atomized. In the indirect electrostatic coating process, the paint or coating particles are charged by means of high voltage after the particles have been atomized. Therefore, apparatuses for indirect charging of particles have external electrodes located such that they charge the particles as they exit the atomizer and the apparatus.

Apparatuses for electrostatically coating workpieces are contaminated while in operation by the coating material which is atomized by the atomizer. Contamination means that particles which are atomized adhere to the outer surface of the different parts of the apparatus, such as the outer housing or the mounting means. Contamination of the apparatus is an important problem in painting operations. Paint particles fail to reach the workpiece to be painted/coated, and some of them may detach from the atomizer body and reach the workpiece while the atomizer is in operation resulting in a poor quality of the painted workpiece.

A further risk is the creation of conductive paint paths, and consequently reduced insulation quality of for example the outer surface of the housing, leading to partial discharges and consequently security stops of the coating operation.

Therefore, the apparatus has to be frequently and regularly cleaned. This is a relatively tedious and time-consuming operation involving lengthy shut-downs which are particularly detrimental to mass production coating. For example, the time for cleaning the apparatus is often approximately the same as the time required for painting two car bodies.

Moreover, it is generally necessary to utilize solvents, for example methylethylketone or butyl cellosolve, for cleaning the outer surface of the apparatus in order to maintain the insulation quality on the outer surface of the apparatus, such as the outer surface of the housing.

U.S. Pat. No. 5,085,373 discloses an apparatus for coating workpieces electrostatically. The apparatus comprises a spraying device having a rotary atomizer, an external housing fabricated from an insulating material, and an internal housing disposed within the external housing. The apparatus utilizes external electrodes for charging the atomized paint particles. U.S. Pat. No. 5,085,373 discloses that the danger of the apparatus coating itself in the area of the electrodes can be reduced by using appropriate insulating materials. The use of fluorocarbons, more specifically polytetrafluorethylene (PTFE), as insulating material are recommended. The contamination is said to be considerably less when using PTFE than with commonly used materials, such as polyoxymethylene (POM). However, PTFE is a fairly soft material and can easily be scratched during cleaning of the apparatus. Therefore, PTFE is not an appropriate material selection.

The object of the invention is consequently to reduce contamination of an apparatus for electrostatically coating workpieces and to improve cleanabilty of the apparatus.

### SUMMARY

The object is achieved by means of an apparatus for electrostatically coating a workpiece in accordance with independent claim 1. The object is further achieved by means of the method for reducing the risk of contamination of an apparatus for electrostatically coating a workpiece in accordance with independent claim 8. Preferred embodiments are given in the dependent claims.

An apparatus for electrostatically coating of workpieces comprises an atomizer, an outer housing of electrically insulating polymer material, the housing surrounding and housing the atomizer, and means for mounting the apparatus to a manipulator, said mounting means having an outer surface of electrically insulating polymer material. The housing and/or mounting means are coated with a generally hydrophobic and hard coating.

The coating on the outer surfaces of the housing and/or the mounting means according to the present invention minimizes the contamination of the surfaces during operation of the apparatus, as well as during shut-down and start-up of the apparatus. Hence, the insulation quality if the outer surfaces can be maintained for a long period of time, i.e. the time between the shut-downs for cleaning of the apparatus according to the present invention is much longer than for previously known coating apparatuses. Hence, the productivity of the apparatus is also improved.

Moreover, the coating facilitates the cleaning of the apparatus since the particles on the surface of the apparatus have less adhesion to the surface.

The coating is generally hydrophobic, i.e. the contact angle of water on the surface of the coating is at least 90°, preferably at least 100°. The hardness of the coating is at least 100 Rockwell, measured according to ASTM D785.

The present invention is especially suitable for apparatuses using direct charging of the atomized paint/coating particles, but may also be used for apparatuses using indirect charging of the atomized paint/coating particles, i.e. apparatuses using external electrodes.

### BRIEF DESCRIPTION OF THE DRAWINGS

FIG. 1a illustrates an apparatus for electrostatically coating a workpiece using indirect charging, the apparatus being mounted on a painting robot.

FIG. 1b illustrates another apparatus for electrostatically coating a workpiece using direct charging, the apparatus being mounted on a painting robot.

FIG. 2 illustrates another apparatus for electrostatically coating a workpiece.

FIG. 3 illustrates a droplet of liquid on a solid surface and the contact angle.

### DETAILED DESCRIPTION

In the present disclosure, a manipulator should be considered to be any means for operating and/or moving the apparatus, such as a robot, a robot arm or a reciprocator.

An apparatus for electrostatically coating a workpiece comprises an atomizer for atomizing paint/coating particles. The atomizer is generally surrounded by a housing of an electrically insulating material. The apparatus is mounted on a manipulator, such as a robot, a robot arm or a reciprocator, by means of mounting means. The apparatus described so far is previously known and commonly used for example for painting vehicles in the automotive industry.

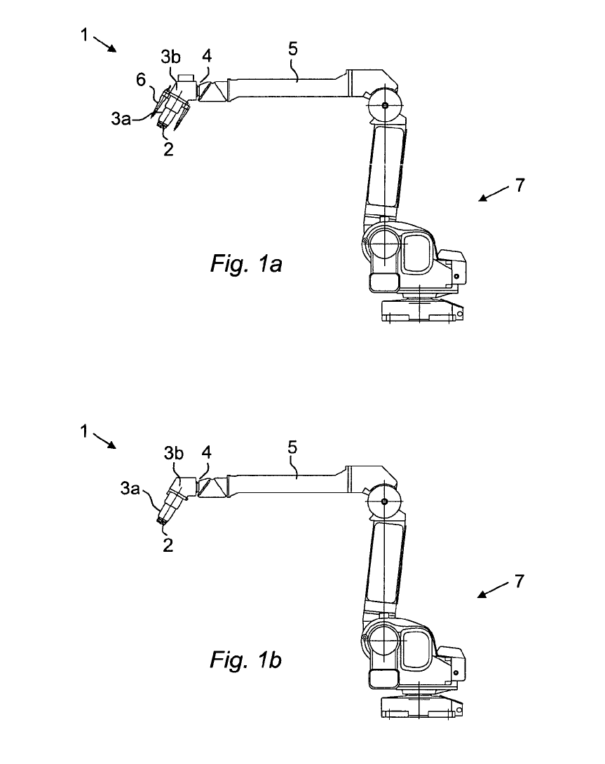

FIG. 1a illustrates one example of an apparatus 1 for electrostatically coating a workpiece. The apparatus 1 comprises an atomizer which is surrounded by a first housing 3a and a second housing 3b, and mounting means 4 for mounting the apparatus 1 to a manipulator in the form of a robot arm 5 of a painting robot 7. The apparatus in FIG. 1a is adapted for indirect charging of particles which are sprayed from the atomizer via its rotary bell 2 and is therefore provided with external electrodes 6 for generating an electrical field.

FIG. 1b illustrates another example of an apparatus 1 for electrostatically coating a workpiece. The apparatus comprises an atomizer which is surrounded by a first housing 3a and a second housing 3b. The apparatus is mounted to a robot arm 5 of a painting robot 7 by mounting means 4. The apparatus in FIG. 1b is adapted for direct charging of the particles and the particles are therefore charged before they leave the apparatus via its rotary bell 2.

Even though the figures above all show embodiments wherein the apparatus is attached to a robot arm by means of the mounting means, it is obvious to the skilled person that the apparatus can be attached to any kind of manipulator by the mounting means. Furthermore, even though a rotary bell has been illustrated in the figures, it is obvious that the particles can be transferred from the atomizer to the workpiece by any other spraying means known for this type of apparatus.

In accordance with the present invention, the housing and/or mounting means are provided with an external coating in order to minimize contamination of the external surfaces of the apparatus during operation and to facilitate cleaning of the apparatus. It has been found that the invention reduces the time for cleaning the apparatus, thus improving productivity of the apparatus since the time for shut-downs are reduced. Furthermore, the invention reduces contamination of the apparatus thereby requiring less shut-downs for cleaning. The insulation quality of the outer surfaces of the apparatus is maintained for longer periods of time due to the reduced contamination, thus minimizing the security stops required when discharges on the surface of the housing and/or mounting means occurs. Moreover, the risk of poor quality of the workpieces coated by means of the apparatus is considerably reduced.

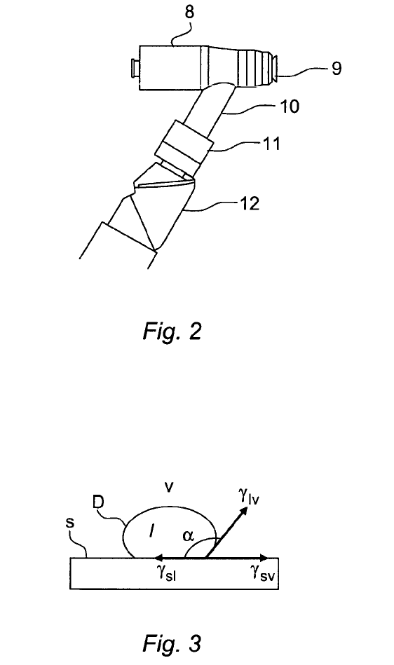

FIG. 2 illustrates another apparatus for electrostatically coating a workpiece. The apparatus comprises an atomizer surrounded by a housing 8 and a rotary atomizing bell 9 from which the particles are transferred to the workpiece. The housing is attached via a neck 10 to mounting means 11. Opposite to the neck 10, the mounting means are mounted to a robot arm 12. The neck 11 shown in the apparatus according to FIG. 2 is preferably also coated with the coating according to the invention in the same manner as the housing and/or mounting means in order to avoid contamination thereof.

The coating applied to the apparatus in accordance with the present invention has a contact angle with water which is at least 90° or more, preferably at least 100°, more preferably at least 105°. This property ensures that the paint particles atomized and charged by the apparatus do not entirely wet the surface of the apparatus. Thereby, contamination of the apparatus is reduced considerably and cleaning of the apparatus is facilitated since the amount of paint on the apparatus surface is much less than on an uncoated apparatus and the paint particles are much less adherent to the surface of the apparatus.

As illustrated in FIG. 3, the contact angle α is the tangent angle at the interface between a droplet D of a liquid l and a solid surface s. The contact angle may be determined at equilibrium by the Young equation:

$$Cos α = \frac{{γ}_{sv} - {γ}_{sl}}{{γ}_{lv}}$$

wherein α is the contact angle, γ represents the surface tension between the corresponding interfaces, and s stands for solid, v for vapor and l for liquid. Methods for measuring the contact angle are commonly known.

Furthermore, it is an essential part of the invention that the coating has sufficient hardness since the apparatuses often also are cleaned mechanically. Using for example a coating of PTFE, which normally has a hardness of 60-85 Rockwell, would not be an appropriate alternative since it would be scratched already at the first cleaning, thus having less resistance to contamination after the first cleaning operation. Therefore, it is a prerequisite in accordance with the invention that the hardness of the coating is at least 100 Rockwell, preferably at least 110 Rockwell, measured in accordance with ASTM D785. Best results are achieved with a coating having a hardness of at least 120 Rockwell.

Cleaning of the outer surfaces of the apparatus is generally performed in the presence of cleaning solvents in order to ensure that the adhered particles are sufficiently dissolved from the surface. Thus, according to a preferred embodiment, the coating is made of a material which, after exposure for a certain period of time to certain cleaning solvents commonly used for cleaning the apparatuses, has a contact angle with water which is not substantially altered compared to its contact angle with water when it is not exposed to said solvents. This means that the contact angle with water after exposure to such solvents has to be at least 80%, preferably at least 90%, of the contact angle with water prior to said exposure. Solvents commonly used for cleaning of apparatuses are methylethylketone and butyl cellosolve. In order to provide sufficient resistance to the cleaning solvents, it is desired that the period which the coating may be subjected to the solvents should be at least 10 minutes, preferably at least 20 minutes.

Preferred coating materials are so called sol-gel coatings, hereinafter called metal oxide sol coatings. Such coatings may be produced by forming a stable dispersion (sol) of particles in a liquid and thereafter by changing concentration, aging or addition of a suitable electrolyte inducing a network structure. The starting materials used in the preparation of the sol are usually inorganic metal salts or metal organic compounds, such as metal alkoxides. These starting materials undergo reactions to form a colloid, i.e. solid particles dispersed in a solvent.

The sol is deposited on the surface by means of conventional methods, such as dipping, flow coating or spraying. Thereafter, the sol is dried, heat treated and/or cured in order to form a hard coating on the surface. The thickness of the coating is preferably at least 0.5 μm in order to ensure a dense and even coating.

Examples of suitable metal oxide sol coatings are disclosed in DE 10 2004 059 152 A1, which is hereby incorporated in its entirety as reference.

According to a preferred embodiment, the metal oxide sol coating is a silica sol coating. Such a coating is commonly known for use in other types of applications, for example as an anti-adhesive topcoat on glass and various metallic materials. According to a particularly preferred embodiment, the coating is a fluorine modified silica sol coating.

The housing may be made of any electrically insulating polymer material commonly used for electrostatically coating apparatuses, such as polyethylene terephtalate (PET), polyacetal such as polyoxymethylene (POM), polyamide (PA), polyethylene (PE), polypropyrene (PP) or the like. Preferably, the housing is made of POM or PA. Thereafter, the external surface of the housing is coated with the coating according to the invention.

The means for mounting the apparatus to a robot or robot arm may suitably have an outer surface of electrically insulating polymer material, such as those mentioned above for the housing. The mounting means are thereafter coated with the coating according to the invention.

For reasons of simplicity, the housing and the mounting means of the apparatus are preferably separately manufactured and coated before assembly of the apparatus. However, it is also possible to coat, or (if needed) to recoat, the housing and/or mounting means after the apparatus has been assembled.

According to a preferred embodiment of the invention, the surface to be coated, i.e. the external surface of the housing and/or of the mounting means, are plasma treated prior to the coating. The purpose of such a plasma treatment is to enhance the adhesion of the coating to the surface to be coated. The plasma is preferably selected based on the specific electrically insulating material used in the surface to be coated. Suitable plasmas are oxygen plasma or argon plasma.

According to an embodiment, the coating is plasma treated after it has been applied to the housing and/or the outer surface of the mounting means. The purpose of said plasma treatment is to enhance the hydrophobicity of the coating and consequently increase the contact angle of water on the coating's surface. The plasma is preferably selected based on the selected coating material and may suitably be a hexamethyldisiloxane plasma or perfluorohexane plasma.

### Example 1

A sample of POM was coated with a silica sol coating known as H 5068 and provided by FEW Chemicals GmbH. The surface of the sample was plasma treated prior to coating in order to enhance the adhesion of the coating. The coating was performed by means of spray coating.

The contact angle of water on the surface of the coated sample was measured in five points using the test apparatus DM500-Kyowa Interface Science Co., Ltd and a drop volume of 10 μl. The contact angle was measured to 108°. The contact angle with n-hexadecane after coating was also determined by the same method to 67°.

### Example 2

The contamination performance of the sample according to Example 1 was tested by spraying the sample with a water borne paint for 30 seconds by air spray gun operating with an air pressure of 0.6 MPa. The sample was placed at the center of the spray pattern and approximately 50 cm from the gun.

The sample was dried in an oven at 80° C. for approximately one hour. Thereafter a first picture of the surface was taken. The sample was subsequently immersed in water based thinner for approximately one minute. The water based thinner consisted of butyl cellosolve, water, dimethylamine, isopropyl alcohol, and ethyl acetate. Excess liquid on the surface was wiped off and a second picture of the sample was taken. Image analysis was performed on the pictures to quantify the degree of paint and of paint removal (color-to background ratio).

For sake of comparison, the same testing operation as described above was performed on an uncoated sample of POM.

Image quantitative analysis of the first picture showed that the coated sample according to Example 1 exhibited approximately 50% less contamination compared to the uncoated sample.

Moreover, image quantitative analysis of the second picture showed that the coated sample according to Example 1 exhibited approximately 200% increase in cleanability compared to the uncoated sample.

### Example 3

The sample of Example 1 was exposed to solvent by wiping the surface of the sample with methylethylketone (MEK). The contact angle of water on the surface was measured in the same manner as in Example 1.

Thereafter, the sample was subjected to solvent borne paint by the paint being poured on half of the sample. Subsequently, the sample was allowed to dry for approximately one hour and thereafter wiped with MEK again. Thereafter contact angle of water on the surface was measured. The procedure was repeated four times and the contact angle was measured after each time.

The results of the contact angle measurements showed that neither the contact angle of water, nor the contact angle of n-hexadecane, were altered as a result of the exposure.

1. An apparatus for electrostatically coating a workpiece, the apparatus comprising:
an atomizer,
an outer housing of electrically insulating polymer material, said housing surrounding and housing the atomizer, and
a mounting module configured to mount the apparatus to a manipulator, said mounting module comprising an outer surface of electrically insulating polymer material,
wherein at least one of the outer housing or the mounting module are externally coated with a coating having a contact angle with water of at least 90° and a hardness according to ASTM D785 of at least 100 Rockwell.

2. The apparatus according to claim 1, wherein the coating has a contact angle with water of at least 100°.

3. The apparatus according to claim 1, wherein the coating, after exposure to at least one of methylethylketone or butyl cellosolve for 10 minutes, has a contact angle with water that is at least 80% of the contact angle with water prior to said exposure.

4. The apparatus according to claim 1, wherein the coating is a metal oxide sol coating.

5. The apparatus according to claim 1, wherein the coating is a silica sol coating.

6. The apparatus according to claim 1, wherein the coating is a fluorine modified silica sol coating.

7. The apparatus according to claim 1, wherein the apparatus is adapted for direct electrostatic charging.

8. A method of reducing the risk of contamination of an apparatus for electrostatically coating a workpiece, said apparatus comprising an atomizer, an outer housing of electrically insulating polymer material, said housing surrounding and housing the atomizer, a mounting module configured to mount the apparatus to a manipulator, said mounting module comprising an outer surface of electrically insulating polymer material, the method comprising:
coating at least one of the housing or the mounting module externally with a coating having a contact angle with water of at least 90° and a hardness according to ASTM D785 of at least 100 Rockwell.

9. The method according to claim 8, wherein the coating has a contact angle with water of at least 100°.

10. The method according to claim 8, wherein the coating, after exposure to at least one of methylethylketone or butyl cellosolve for 10 minutes has a contact angle with water that is at least 80% of the contact angle with water prior to said exposure.

11. The method according to claim 8, wherein the coating is a metal oxide sol coating.

12. The method according to claim 8, wherein the coating is a silica sol coating.

13. The method according to claim 8, wherein the coating is a fluorine modified silica sol coating.

14. The method according to claim 8, wherein the external surface of at least one of the housing or the mounting module is plasma treated prior to said coating in order to enhance the adhesion of the coating.

15. The method according to claim 14, wherein the plasma is an argon or an oxygen plasma.

16. The method according to claim 8, wherein the coating is plasma treated in order to increase the hydrophobicity of the coating.

17. The method according to claim 16, wherein the plasma is a hexamethyldisiloxane or a perfluorohexane plasma.
